(19) United States
(12) Patent Application Publication
(10) Pub. No.: US 2022/0344760 A1
(43) Pub. Date: Oct. 27, 2022

(54) ENERGY STORAGE APPARATUS

(71) Applicant: GS Yuasa International Ltd., Kyoto-shi (JP)

(72) Inventors: Takaaki ISHIKAWA, Kyoto-shi, Kyoto (JP); Takuya NAKAHATA, Kyoto-shi, Kyoto (JP)

(21) Appl. No.: 17/630,276

(22) PCT Filed: Jul. 6, 2020
(86) PCT No.: PCT/JP2020/026428

§ 371 Date: Jan. 26, 2022

(30) Foreign Application Priority Data
Aug. 8, 2019 (JP) 2019-146487

(51) Int. Cl. H01M 50/244; H01M 50/211; H01M 50/249

(52) U.S. Cl. CPC H01M 50/244; H01M 50/211; H01M 50/249

(57) ABSTRACT

An energy storage apparatus includes: an energy storage device; an adjacent member arranged adjacent to the energy storage device; and an adhesive material which adheres the energy storage device and the adjacent member to each other, in which the energy storage device includes an adhesive surface to be adhered to the adjacent member by the adhesive material, and the adhesive surface includes an uneven surface on which an uneven shape spreads in a planar shape.

### TECHNICAL FIELD

The present invention relates to an energy storage apparatus including an energy storage device.

### BACKGROUND ART

Conventionally, there has been known an energy storage apparatus including an energy storage device and an adjacent member arranged adjacent to the energy storage device, and in which the energy storage device and the adjacent member are adhered to each other. Patent Document 1 discloses an assembled battery (energy storage apparatus) including a plurality of battery cells (energy storage devices) and a holder (adjacent member) that holds the battery cells, in which the battery cells and the holder are adhered to each other.

### PRIOR ART DOCUMENT

### Patent Document

Patent Document 1: JP-A-2018-125194

### SUMMARY OF THE INVENTION

### Problems to be Solved by the Invention

In the energy storage apparatus, a configuration capable of further suppressing movement of the energy storage device in the energy storage apparatus is desired.

An object of the present invention is to provide an energy storage apparatus capable of suppressing movement of an energy storage device.

### Means for Solving the Problems

An energy storage apparatus according to one aspect of the present invention includes: an energy storage device; an adjacent member arranged adjacent to the energy storage device; and an adhesive material which adheres the energy storage device and the adjacent member to each other, in which the energy storage device includes an adhesive surface to be adhered to the adjacent member by the adhesive material, and the adhesive surface includes an uneven surface on which an uneven shape spreads in a planar shape.

The present invention can be realized not only as such an energy storage apparatus but also as the energy storage device having the adhesive surface (first adhesive surface) or the adjacent member having a second adhesive surface.

### Advantages of the Invention

According to the energy storage apparatus of the present invention, the movement of the energy storage device can be suppressed.

### BRIEF DESCRIPTION OF THE DRAWINGS

FIG. 1 is a perspective view showing an external appearance of an energy storage apparatus according to an embodiment.

FIG. 2 is an exploded perspective view showing respective components when the energy storage apparatus according to the embodiment is disassembled.

FIG. 3 is a perspective view showing a configuration of an energy storage device according to the embodiment.

FIG. 4 is a plan view showing an adhering portion between the energy storage devices and a bus bar frame according to the embodiment.

FIG. 5 is an enlarged cross-sectional view showing a state where the energy storage devices and the bus bar frame according to the embodiment are adhered to each other.

FIG. 6 is a plan view showing an adhering portion between the energy storage devices and an outer case according to the embodiment.

FIG. 7 is an enlarged cross-sectional view showing a state where the energy storage devices and the outer case according to the embodiment are adhered to each other.

FIG. 8 is an enlarged cross-sectional view showing a state where the energy storage devices and the outer case according to a first modification example of the embodiment are adhered to each other.

FIG. 9 is an enlarged cross-sectional view showing a state where the energy storage devices and the bus bar frame according to a second modification example of the embodiment are adhered to each other.

### MODE FOR CARRYING OUT THE INVENTION

The movement of the energy storage device in the energy storage apparatus can be suppressed by adhering the energy storage device to the adjacent member and fixing the energy storage device to the adjacent member as in the conventional energy storage apparatus. However, when a large vibration or impact is applied from the outside or the like, there is a possibility that adhesion between the energy storage device and the adjacent member is released and the energy storage device moves in the energy storage apparatus. Therefore, a configuration capable of further suppressing the movement of the energy storage device in the energy storage apparatus is desired.

An object of the present invention is to provide an energy storage apparatus capable of suppressing movement of an energy storage device.

An energy storage apparatus according to one aspect of the present invention includes: an energy storage device; an adjacent member arranged adjacent to the energy storage device; and an adhesive material which adheres the energy storage device and the adjacent member to each other, in which the energy storage device includes an adhesive surface to be adhered to the adjacent member by the adhesive material, and the adhesive surface includes an uneven surface on which an uneven shape spreads in a planar shape.

With such a configuration, in the energy storage apparatus, the energy storage device includes the adhesive surface to be adhered to the adjacent member, which is adjacent to the energy storage device, by the adhesive material, and the adhesive surface includes the uneven surface on which an uneven shape spreads in a planar shape. In this manner, by forming the uneven surface on which an uneven shape spreads in a planar shape on the adhesive surface of the energy storage device to the adjacent member, the adhesion area of the adhesive surface can be increased. With such a configuration, it is possible to improve an adhesive force between the energy storage device and the adjacent member, and hence the movement of the energy storage device in the energy storage apparatus can be suppressed.

The adhesive surface may include an uneven surface which is rougher than a surface adjacent to the adhesive surface or a surface on a back side of the adhesive surface.

With such a configuration, the adhesive surface of the energy storage device to the adjacent member includes the uneven surface which is rougher than the surface adjacent to the adhesive surface or the surface on the back side. In this manner, by making the uneven surface of the adhesive surface of the energy storage device rougher than the other surface (the adjacent surface or the surface on the back side), the adhesive force on the uneven surface can be improved. With such a configuration, it is possible to improve an adhesive force between the energy storage device and the adjacent member, and hence the movement of the energy storage device in the energy storage apparatus can be suppressed.

The adhesive surface may include an uneven surface arranged on a bottom surface of the energy storage device.

With such a configuration, the adhesive surface of the energy storage device to the adjacent member includes the uneven surface on the bottom surface of the energy storage device. That is, the energy storage device can be stably fixed in the energy storage apparatus in many cases by adhering the bottom surface of the energy storage device to the adjacent member (the outer case or the like), and hence the uneven surface is provided on the bottom surface of the energy storage device. With such a configuration, by improving the adhesive force between the bottom surface of the energy storage device and the adjacent member (outer case or the like), the energy storage device can be more stably fixed in the energy storage apparatus, and hence the movement of the energy storage device in the energy storage apparatus can be further suppressed.

The adhesive surface may include an uneven surface arranged on a surface of the energy storage device on a side opposite to an electrode terminal.

With such a configuration, the adhesive surface of the energy storage device to the adjacent member includes the uneven surface on the surface on the side opposite to the electrode terminal. That is, the movement of the electrode terminal side of the energy storage device is bound by the electrode terminal being connected to a bus bar, but the side of the energy storage device which is opposite to the electrode terminal is easily moved. Thus, the uneven surface is formed on the surface of the energy storage device on the side opposite to the electrode terminal. With such a configuration, by improving the adhesive force between the surface of the energy storage device on the side opposite to the electrode terminal and the adjacent member (outer case or the like), the movement of the side of the energy storage device which is opposite to the electrode terminal can also be suppressed, and hence the movement of the energy storage device in the energy storage apparatus can be further suppressed.

A surface of the energy storage device on which the electrode terminal is arranged may include an adhesive region to be adhered to the adjacent member and a non-adhesive region not to be adhered to the adjacent member, and the adhesive surface may include an uneven surface which is arranged in the adhesive region and is rougher than the non-adhesive region.

With such a configuration, the adhesive surface of the energy storage device to the adjacent member includes the uneven surface which is arranged in the adhesive region of the surface of the energy storage device on the electrode terminal side and is rougher than the non-adhesive region. That is, when the adjacent member (bus bar frame or the like) is adhered to the surface of the energy storage device on the electrode terminal side, the adjacent member is adhered to a part of the surface (adhesive region) so as to avoid a gas release valve, the electrode terminal, and the like. For this reason, on the surface of the energy storage device on the electrode terminal side, an uneven surface including an uneven shape rougher than the non-adhesive region is formed in the adhesive region. With such a configuration, it is possible to improve an adhesive force between a surface of the energy storage device on an electrode terminal side and an adjacent member (bus bar frame or the like), and hence movement of the energy storage device in the energy storage apparatus can be suppressed.

An energy storage apparatus according to another aspect of the present invention includes: an energy storage device; and an adjacent member arranged adjacent to the energy storage device, in which the energy storage device includes a first adhesive surface which is a bottom surface or a surface on a side opposite to an electrode terminal and is to be adhered to the adjacent member, in which the adjacent member includes a second adhesive surface to be adhered to the first adhesive surface, and in which at least one of the first adhesive surface and the second adhesive surface includes an uneven surface on which an uneven shape spreads in a planar shape.

With such a configuration, in the energy storage apparatus, at least one of the first adhesive surface which is the bottom surface of the energy storage device or the surface on the opposite side to the electrode terminal and the second adhesive surface of the adjacent member includes the uneven surface on which an uneven shape spreads in a planar shape. In this manner, by forming the uneven surface on which an uneven shape spreads in a planar shape on at least one of the first adhesive surface of the energy storage device and the second adhesive surface of the adjacent member, the adhesion area of the adhesive surface can be increased. With such a configuration, it is possible to improve the adhesive force between the energy storage device and the adjacent member. In particular, by improving the adhesive force between the bottom surface of the energy storage device and the adjacent member (outer case or the like), the energy storage device can be more stably fixed in the energy storage apparatus. By improving the adhesive force between the surface of the energy storage device on the side opposite to the electrode terminal and the adjacent member (outer case or the like), the movement of the side of the energy storage device which is opposite to the electrode terminal, which is not bound in movement by the bus bar, can also be suppressed. Accordingly, the movement of the energy storage device in the energy storage apparatus can be further suppressed.

Hereinafter, an energy storage apparatus according to an embodiment of the present invention (including modification examples thereof) will be described with reference to the drawings. The embodiment described below describes a comprehensive or specific example. The numerical values, shapes, materials, components, positions for arranging the components and connection forms of the components, manufacturing processes, the order of the manufacturing processes, and the like described in the following embodiment are merely examples, and are not intended to limit the present invention. In each drawing, dimensions and the like are not strictly shown.

In the following description and drawings, an arrangement direction of energy storage devices or a facing direction of long side surfaces of a case of the energy storage device is defined as an X-axis direction. An arrangement direction of a pair of (positive electrode side and negative electrode side) electrode terminals in one energy storage device or a facing direction of short side surfaces of a case of the energy storage device is defined as a Y axis direction. An arrangement direction of an outer case body and a lid body of the energy storage apparatus, an arrangement direction of a case body and a lid portion of the energy storage device, an arrangement direction of the energy storage devices and a bus bar frame, or a vertical direction is defined as a Z-axis direction. The X-axis direction, the Y-axis direction, and the Z-axis direction are directions intersecting (orthogonal in the present embodiment) each other. Although it is considered that the Z-axis direction may not be the vertical direction depending on the usage mode, the Z-axis direction will be described below as the vertical direction for convenience of description.

In the following description, the X-axis plus direction indicates an arrow direction of the X axis, and the X-axis minus direction indicates a direction opposite to the X-axis plus direction. The same applies to the Y-axis direction and the Z-axis direction. Expressions indicating relative directions or postures, such as parallel and orthogonal include cases of being not strictly the directions or postures. Two directions being orthogonal to each other not only means that the two directions are completely orthogonal to each other, but also means that the two directions are substantially orthogonal to each other, that is, a difference of about several percent is allowed.

### EMBODIMENT

### 1 General Description of Energy Storage Apparatus 10

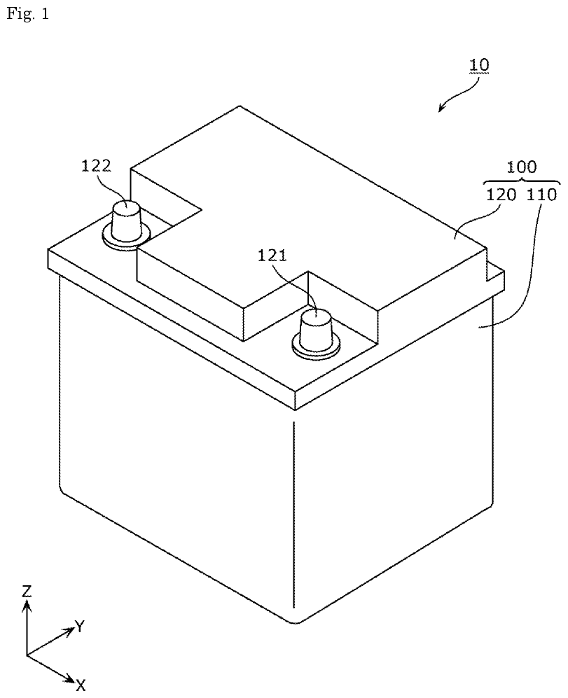

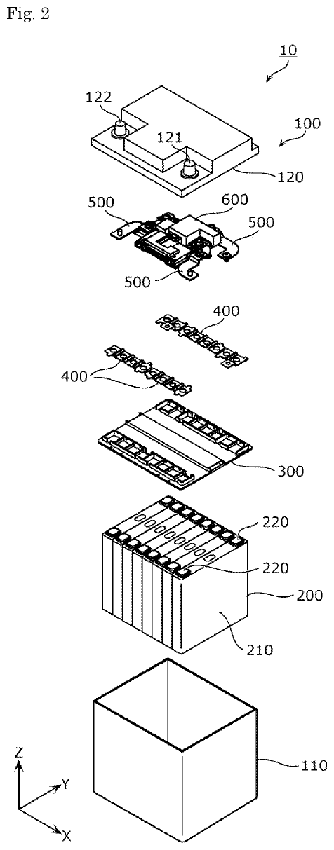

First, general description of an energy storage apparatus 10 according to the present embodiment will be made. FIG. 1 is a perspective view showing an external appearance of the energy storage apparatus 10 according to the present embodiment. FIG. 2 is an exploded perspective view showing respective components when the energy storage apparatus 10 according to the present embodiment is disassembled.

The energy storage apparatus 10 is an apparatus capable of charging electricity from the outside and discharging electricity to the outside, and has a substantially rectangular parallelepiped shape in the present embodiment. The energy storage apparatus 10 is a battery module (assembled battery) used for power storage application, power supply application, or the like. Specifically, the energy storage apparatus 10 is used as a battery or the like for driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a gasoline vehicle. Examples of the railway vehicle for an electric railway include a train, a monorail, and a linear motor car. The energy storage apparatus 10 can also be used as a stationary battery or the like used for home use, a generator, or the like.

As shown in FIG. 1, the energy storage apparatus 10 includes an outer case 100, and as shown in FIG. 2, a plurality of energy storage devices 200, a bus bar frame 300, a plurality of bus bars 400 and 500, an electric device 600, and the like are accommodated in the inside of the outer case 100. The energy storage apparatus 10 may include a spacer or the like arranged between the plurality of energy storage devices 200.

The outer case 100 is a case (module case) having a box shape (substantially rectangular parallelepiped shape) which forms an outer case of the energy storage apparatus 10. That is, the outer case 100 is arranged outward the plurality of energy storage devices 200, the bus bar frame 300, the plurality of bus bars 400 and 500, and the like, and fixes the energy storage devices 200 and the like at predetermined positions so as to be protected from an impact or the like. The outer case 100 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof, or an insulation-coated metal. With such a configuration, the outer case 100 prevents the energy storage devices 200 and the like from coming into contact with an external metal member or the like. The outer case 100 may be formed of a conductive member such as metal as long as the electric insulation property of the energy storage devices 200 and the like is maintained.

The outer case 100 includes an outer case body 110 which forms a body of the outer case 100 and a lid body 120 which forms a lid body of the outer case 100. The outer case body 110 is a bottomed rectangular cylindrical housing (casing) in which an opening is formed, and accommodates the energy storage devices 200 and the like therein. The lid body 120 is a flat rectangular member which is joined to the outer case body 110 by heat sealing or the like to close the opening of the outer case body 110. The lid body 120 is provided with a positive electrode external terminal 121 and a negative electrode external terminal 122. The energy storage apparatus 10 charges electricity from the outside and discharges electricity to the outside through the positive electrode external terminal 121 and the negative electrode external terminal 122. The outer case body 110 and the lid body 120 may be formed of members made of the same material, or may be formed of members made of different materials. The outer case 100 (outer case body 110) is an example of an adjacent member arranged adjacent to the energy storage devices 200.

The energy storage device 200 is a secondary battery (battery cell) capable of charging and discharging electricity, and more specifically, is a nonaqueous electrolyte secondary battery such as a lithium ion secondary battery. The energy storage device 200 has a flat rectangular parallelepiped shape (prismatic shape), and in the present embodiment, eight energy storage devices 200 are arranged side by side in the X axis direction. The shape of the energy storage device 200 and the number of energy storage devices 200 arranged are not limited. The energy storage device 200 is not limited to the nonaqueous electrolyte secondary battery, and may be a secondary battery other than the nonaqueous electrolyte secondary battery, or may be a capacitor. The energy storage device 200 may be not a secondary battery but a primary battery that can use stored electricity unless being charged by a user. The energy storage device 200 may be a battery using a solid electrolyte. The energy storage device 200 may be a pouch type energy storage device.

To be more specific, the energy storage device 200 includes a case 210, a pair of (positive electrode side and negative electrode side) electrode terminals 220 (a positive electrode terminal and a negative electrode terminal), and the like. The configurations of those energy storage devices 200 will be described in detail later.

The bus bar frame 300 is a rectangular flat-plate-like member that electrically insulates the bus bars 400, the electric device 600, and the like from other members, and restricts the positions of the bus bars 400, the electric device 600, and the like. To be more specific, the bus bars 400, the electric device 600, and the like are positioned by being mounted on the bus bar frame 300, and the bus bar frame 300 is positioned with respect to the plurality of energy storage devices 200 by being mounted on the plurality of energy storage devices 200. With such a configuration, the bus bars 400 are positioned with respect to the plurality of energy storage devices 200. The bus bar frame 300 is formed of an insulating material or the like similar to the material exemplified for the outer case 100. The bus bar frame 300 is an example of an adjacent member arranged adjacent to the energy storage device 200.

The bus bars 400 and 500 are rectangular flat-plate-like members which are arranged above the plurality of energy storage devices 200 and are connected to the electrode terminals 220 of the plurality of energy storage devices 200, the positive electrode external terminal 121, and the negative electrode external terminal 122. That is, the bus bars 400 and 500 connect the electrode terminals 220 of the plurality of energy storage devices 200 to each other, and connect the electrode terminals 220 of the energy storage devices 200 at the end portions to the positive electrode external terminal 121 and the negative electrode external terminal 122. The bus bars 400 and 500 are formed of a conductive member made of metal such as aluminum, an aluminum alloy, copper, or a copper alloy. In the present embodiment, the bus bars 400 connect two energy storage devices 200 in parallel to form four sets of energy storage device groups, and connect the four sets of energy storage device groups in series. However, the bus bars 400 may connect all eight energy storage devices 200 in series, or may have other configurations.

The electric device 600 is an electric component mounted on the bus bar frame 300. The electric device 600 includes electric components such as a circuit board, a fuse, a relay, a shunt resistor, and a connector for monitoring a charge state or a discharge state of the energy storage device 200. The electric device 600 is connected to the bus bars 500, and is electrically connected to the energy storage devices 200, the positive electrode external terminal 121, the negative electrode external terminal 122, and the like.

### 2 Description of Configuration of Energy Storage Device 200

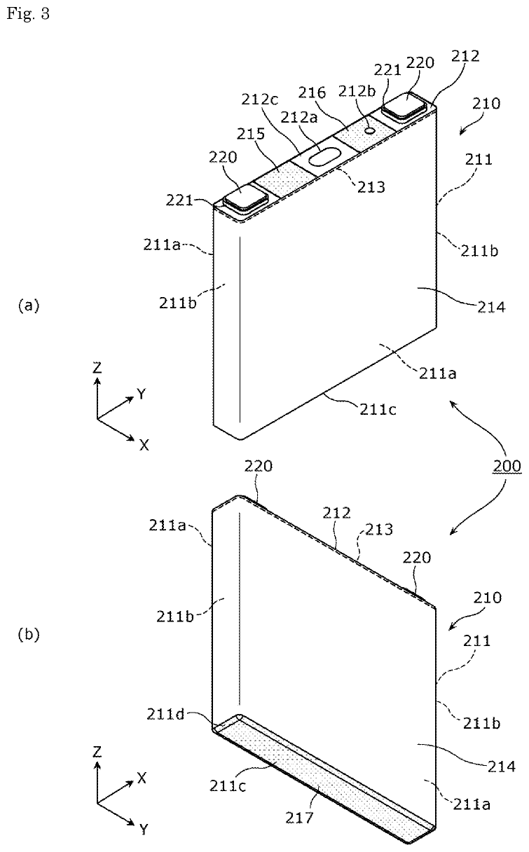

Next, the configuration of the energy storage device 200 will be described in detail. Since all of the plurality of (eight) energy storage devices 200 shown in FIG. 2 have the same configuration, the configuration of one energy storage device 200 will be described below. FIG. 3 is a perspective view showing the configuration of the energy storage device 200 according to the present embodiment. To be more specific, (a) of FIG. 3 is a perspective view showing the energy storage device 200 shown in FIG. 2 in an enlarged manner, and (b) of FIG. 3 is a perspective view showing a configuration of the energy storage device 200 shown in (a) of FIG. 3 as viewed from below (on the Z-axis minus direction side).

As shown in FIG. 3, the energy storage device 200 includes the case 210, the pair of (positive electrode side and negative electrode side) electrode terminals 220, and a pair of (positive electrode side and negative electrode side) gaskets 221. An electrode assembly, a pair of (positive electrode side and negative electrode side) current collectors, an electrolyte solution (nonaqueous electrolyte), and the like are accommodated in the case 210, but illustration thereof is omitted. A type of the electrolyte solution is not particularly limited as long as performance of the energy storage device 200 is not impaired, and various types of electrolyte solutions can be selected. A gasket is also arranged between the case 210 (the lid portion 212 described later) and the current collector, and a spacer is arranged on a side or the like of the current collector, but illustration thereof is also omitted.

The case 210 is a rectangular parallelepiped (prismatic) case including a case body 211 in which an opening is formed and the lid portion 212 that closes the opening of the case body 211. The material of the case 210 (the case body 211 and the lid portion 212) is not particularly limited, but is preferably weldable (joinable) metal such as stainless steel, aluminum, an aluminum alloy, iron, or a plated steel plate. An insulating sheet 214 is arranged on an outer surface of the case body 211.

The lid portion 212 is a rectangular plate-like member constituting a lid portion of the case 210, and is arranged on the Z-axis plus direction side of the case body 211. The lid portion 212 is provided with a gas release valve 212a that releases the pressure when the pressure in the case 210 increases, and an electrolyte solution filling portion 212b for injecting an electrolyte solution into the case 210. The lid portion 212 has a terminal arrangement surface 212c on which the electrode terminals 220 are arranged. The terminal arrangement surface 212c is a rectangular flat surface (outer surface or upper surface) arranged on the Z-axis plus direction side of the lid portion 212 and extending in the Y-axis direction.

A first uneven surface 215 and a second uneven surface 216 are formed on the terminal arrangement surface 212c of the lid portion 212. The first uneven surface 215 is an uneven surface which is formed in a rectangular region on the terminal arrangement surface 212c between the electrode terminal 220 on the Y-axis minus direction side and the gas release valve 212a and on which an uneven shape spreads in a planar shape. The second uneven surface 216 is an uneven surface which is formed in a rectangular region on the terminal arrangement surface 212c between the electrode terminal 220 on the Y-axis plus direction side and the gas release valve 212a and on which an uneven shape spreads in a planar shape. In the present embodiment, the second uneven surface 216 is formed in a portion other than the electrolyte solution filling portion 212b in the region. As described above, on the terminal arrangement surface 212c, the uneven surface on which the uneven shape spreads in a planar shape is formed at a portion other than the electrode terminals 220, the gas release valve 212a, and the electrolyte solution filling portion 212b. The second uneven surface 216 may also be formed on the surface of the electrolyte solution filling portion 212b.

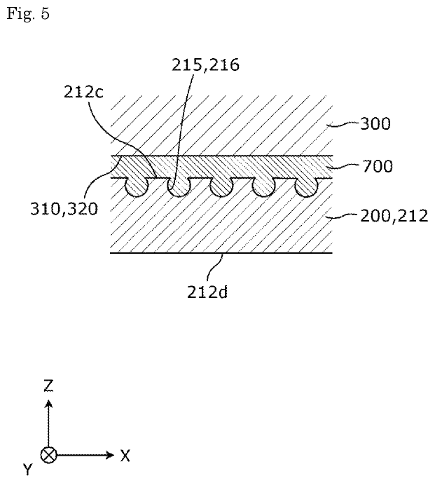

The uneven surface is a surface (for example, a satin surface) in which an uneven shape rougher than other surfaces (a surface adjacent to the uneven surface, a surface on a back side of the uneven surface, or the like) spreads in a planar shape. That is, the uneven surface is a surface having concave portions or convex portions larger than the other surfaces even when the concave portion or the convex portion spreading in a planar shape is formed on the other surfaces. For example, the first uneven surface 215 is a surface which is rougher than surfaces adjacent to the first uneven surface 215 on both sides thereof in the Y axis direction, surfaces adjacent to the terminal arrangement surface 212c (long side surfaces 211a and short side surfaces 211b described later of the case body 211), or a surface on the back side of the terminal arrangement surface 212c (a lid portion inner surface 212d in FIG. 5). The same applies to the second uneven surface 216. Such an uneven surface can be formed by sand blasting, plasma, corona, etching, shot peening, pressing, or the like. Whether or not the uneven surface is formed can be determined by observing the surface after an adhesive material 700 described later is removed, or determined by a difference in color from a portion where the uneven surface is not formed. Whether or not the uneven surface is formed can be visually determined, for example.

The roughness (size of the concave portions or the convex portions) of the uneven surface can be defined by the maximum height Rz. The maximum height Rz is a value obtained by extracting a part of the roughness curve with a reference length and adding a value of the height of the highest portion and a value of the depth of the deepest portion of the extracted portion. For example, in the roughness of the uneven surface, Rz is preferably 0.05 z or more, more preferably 1.6 z or more, still more preferably 12.5 z or more, and still more preferably 15 z or more. The roughness of the uneven surface is preferably equal to or more than the roughness formed by plasma treatment, and more preferably equal to or more than the roughness formed by processing other than plasma treatment such as sand blasting. When the case 210 made of an aluminum material or the like is subjected to sandblasting, the roughness of the uneven surface preferably has Rz of 15 z or more. On the uneven surface, concave portions having a shape in which a width of a tip portion increases as a depth increases (or convex portions having a shape in which the width increases toward the tip) are preferably formed (see FIG. 5). The roughness of the uneven surface may be defined by an arithmetic average roughness Ra or a numerical value expressing another roughness.

The case body 211 is a member having a rectangular cylindrical shape and a bottom constituting a body portion of the case 210, and has two long side surfaces 211a facing each other on side surfaces on both sides in the X-axis direction, two short side surfaces 211b facing each other on side surfaces on both sides in the Y-axis direction, and a bottom surface 211c on the Z-axis minus direction side. The long side surface 211a is a rectangular flat surface forming the long side surface of the case 210. In other words, the long side surface 211a is a surface adjacent to the short side surfaces 211b, the bottom surface 211c, and the terminal arrangement surface 212c and having an area larger than that of the short side surface 211b. The short side surface 211b is a rectangular flat surface forming the short side surface of the case 210. In other words, the short side surface 211b is a surface adjacent to the long side surfaces 211a, the bottom surface 211c, and the terminal arrangement surface 212c and having an area larger than that of the long side surface 211a. The bottom surface 211c is a rectangular flat surface forming the bottom surface of the case 210. In other words, the bottom surface 211c is a surface facing the terminal arrangement surface 212c and adjacent to the long side surfaces 211a and the short side surfaces 211b. That is, it can be said that the bottom surface 211c is a surface of the energy storage device 200 on a side opposite to the electrode terminals 220. The case body 211 has a curved case corner portion 211d at a boundary portion between the bottom surface 211c and the long side surfaces 211a and the short side surfaces 211b.

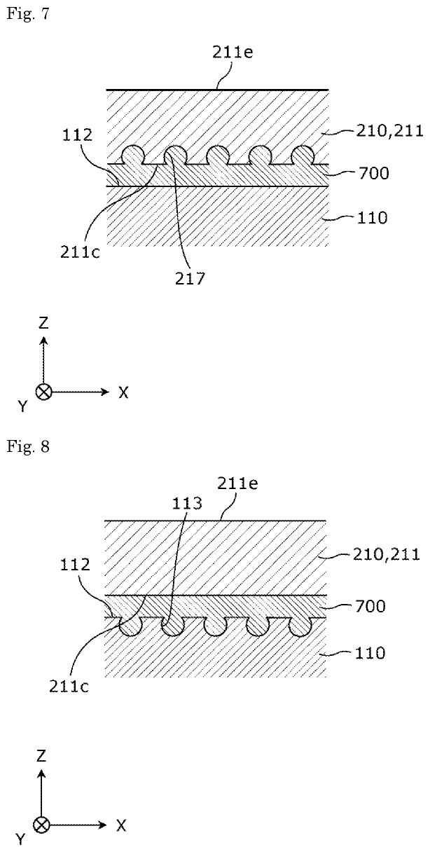

A third uneven surface 217 is formed on the bottom surface 211c and the case corner portion 211d of the case body 211. The third uneven surface 217 is an uneven surface on which an uneven shape similar to those of the first uneven surface 215 and the second uneven surface 216 described above spreads in a planar shape. That is, for example, the third uneven surface 217 is a surface which is rougher than surfaces adjacent to the bottom surface 211c (the long side surfaces 211a and the short side surfaces 211b) or a surface on the back side of the bottom surface 211c (a bottom surface inner surface 211e in FIG. 7). A specific value of the roughness (size of the concave portions or the convex portions) of the uneven surface is the same as those of the first uneven surface 215 and the second uneven surface 216 described above. The third uneven surface 217 may not be formed in the case corner portion 211d, but is preferably formed also in the case corner portion 211d from the viewpoint of improving the adhesive force.

The insulating sheet 214 is a sheet-like member having insulation property that covers the outer surface of the case body 211. The material of the insulating sheet 214 is not particularly limited as long as the material can secure the electric insulation property required for the energy storage device 200, and examples thereof include the same insulating material as the material exemplified for the outer case 100, or epoxy resin, Kapton, Teflon (registered trademark), silicon, polyisoprene, polyvinyl chloride, and the like. Specifically, the insulating sheet 214 is one insulating sheet arranged so as to cover substantially the entire surfaces of the long side surfaces 211a and the short side surfaces 211b of the case body 211. As described above, the insulating sheet 214 is arranged on the outer surface of the case body 211 in a state where the terminal arrangement surface 212c and the bottom surface 211c are exposed.

In such a configuration, first, the third uneven surface 217 is formed on the bottom surface 211c and the case corner portion 211d of the case body 211, and the first uneven surface 215 and the second uneven surface 216 are formed on the terminal arrangement surface 212c of the lid portion 212. The electrode assembly and the like are accommodated in the inside of the case body 211, and the case body 211 and the lid portion 212 are joined to each other by welding or the like to form a joint portion 213. That is, the joint portion 213 where the case body 211 and the lid portion 212 are joined to each other is formed on the side surfaces (surfaces on both sides in the X axis direction and both sides in the Y axis direction) of the case 210. The electrolyte solution is injected into the case body 211, the electrolyte solution filling portion 212b is closed, and the inside is sealed. The long side surfaces 211a and the short side surfaces 211b of the case body 211 are covered with the insulating sheet 214.

The electrode terminals 220 are terminals (the positive electrode terminal and the negative electrode terminal) of the energy storage device 200 which are arranged on the terminal arrangement surface 212c of the case 210, and are electrically connected to a positive electrode plate and a negative electrode plate of the electrode assembly via the current collectors. That is, the electrode terminals 220 are metal members for leading out electricity stored in the electrode assembly to a space outside the energy storage device 200 and for introducing electricity into a space inside the energy storage device 200 so as to store electricity in the electrode assembly. The electrode terminals 220 are made of aluminum, an aluminum alloy, copper, a copper alloy, or the like. The gaskets 221 are each arranged around the electrode terminal 220 and between the electrode terminal 220 and the lid portion 212 of the case 210, and is a member for ensuring electric insulation property and airtightness between the electrode terminal 220 and the case 210. The gaskets 221 are formed of an insulating material or the like similar to the material exemplified for the outer case 100.

The electrode assembly is an energy storage element (power generating element) formed by stacking the positive electrode plate, the negative electrode plate, and a separator. The positive electrode plate included in the electrode assembly is obtained by forming a positive active material layer on a positive electrode substrate layer which is a long belt-shaped current collecting foil made of metal such as aluminum or an aluminum alloy. The negative electrode plate is obtained by forming a negative active material layer on a negative electrode substrate layer which is a long belt-shaped current collecting foil made of metal such as copper or a copper alloy. As the positive active material used for the positive active material layer and the negative active material used for the negative active material layer, known materials can be appropriately used as long as they can occlude and release lithium ions. The current collectors are members having conductivity and rigidity (a positive electrode current collector and a negative electrode current collector) electrically connected to the electrode terminals 220 and the electrode assembly. The positive electrode current collector is formed of aluminum, an aluminum alloy, or the like similarly to the positive electrode substrate layer of the positive electrode plate, and the negative electrode current collector is formed of copper, a copper alloy, or the like similarly to the negative electrode substrate layer of the negative electrode plate.

### 3 Description of Adhesive Configuration Between Energy Storage Devices 200 and Adjacent Members

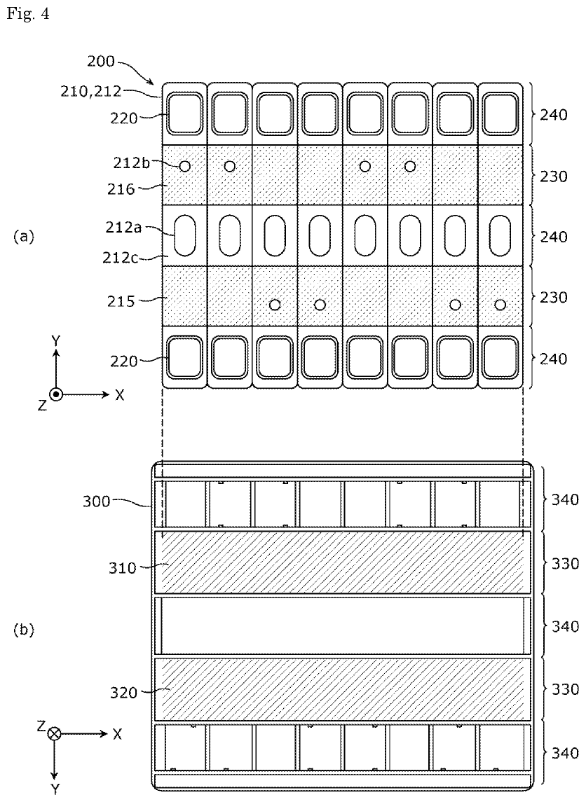

Next, an adhesive configuration between the energy storage devices 200 and the adjacent members (the outer case 100 and the bus bar frame 300) is described in detail. FIG. 4 is a plan view showing an adhering portion between the energy storage devices 200 and the bus bar frame 300 according to the present embodiment. To be more specific, (a) of FIG. 4 is a top view showing a configuration of the plurality of energy storage devices 200 shown in FIG. 2 when viewed from above (Z-axis plus direction side). (b) of FIG. 4 is a bottom view showing a configuration of the bus bar frame 300 when viewed from below (Z-axis minus direction side). FIG. 5 is an enlarged cross-sectional view showing a state where the energy storage devices 200 and the bus bar frame 300 according to the present embodiment are adhered to each other.

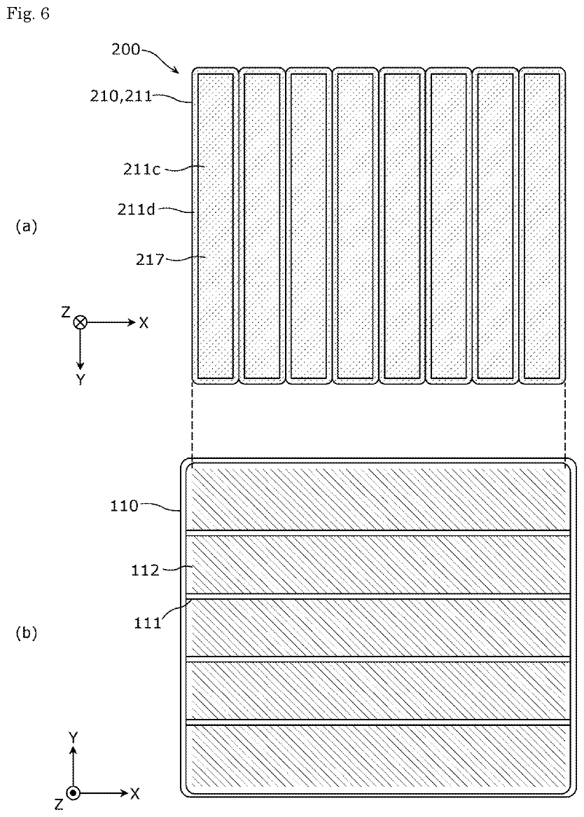

FIG. 6 is a plan view showing an adhering portion between the energy storage devices 200 and the outer case 100 according to the present embodiment. To be more specific, (a) of FIG. 6 is a bottom view showing a configuration of the plurality of energy storage devices 200 shown in FIG. 2 when viewed from below (Z-axis minus direction side). (b) of FIG. 6 is a top view showing a configuration of the outer case body 110 of the outer case 100 when viewed from above (Z-axis plus direction side). FIG. 7 is an enlarged cross-sectional view showing a state where the energy storage devices 200 and the outer case 100 according to the present embodiment are adhered to each other.

As shown in FIG. 4, the terminal arrangement surface 212c which is a surface of the energy storage device 200 on which the electrode terminals 220 are arranged has adhesive regions 230 which are adhered to the bus bar frame 300 (adjacent member) and non-adhesive regions 240 which are not adhered to the bus bar frame 300 (adjacent member). That is, the terminal arrangement surface 212c is an adhesive surface to be adhered to the bus bar frame 300 (adjacent member).

The adhesive regions 230 are regions in the terminal arrangement surface 212c where the first uneven surface 215 and the second uneven surface 216 are formed. The non-adhesive regions 240 are regions in the terminal arrangement surface 212c where the first uneven surface 215 and the second uneven surface 216 are not formed. In other words, the non-adhesive regions 240 are regions in the terminal arrangement surface 212c where the electrode terminals 220 and the gas release valve 212a are arranged. That is, the terminal arrangement surface 212c (adhesive surface) has the first uneven surface 215 and the second uneven surface 216 which are the uneven surfaces arranged in the adhesive regions 230 and rougher than the non-adhesive regions 240.

The bus bar frame 300 has a planar adhesive surface 310 and a planar adhesive surface 320 at positions facing the first uneven surfaces 215 and the second uneven surfaces 216. Specifically, the adhesive surface 310 faces one of the first uneven surfaces 215 and the second uneven surfaces 216, and the adhesive surface 320 is arranged at a position facing the other of the first uneven surfaces 215 and the second uneven surfaces 216. Regions where the adhesive surfaces 310 and 320 are formed are defined as adhesive regions 330, and regions where the adhesive surfaces 310 and 320 are not formed are defined as non-adhesive regions 340. That is, the adhesive regions 230 of the energy storage devices 200 are arranged so as to face the adhesive regions 330 of the bus bar frame 300 and are adhered to the adhesive regions 330. In other words, the energy storage devices 200 are adhered to the adhesive surfaces 310 and 320 of the bus bar frame 300 in the first uneven surfaces 215 and the second uneven surfaces 216 of the terminal arrangement surfaces 212c.

To be more specific, as shown in FIG. 5, the bus bar frame 300 (adjacent member) is arranged adjacent to the energy storage devices 200 with the adhesive material 700 interposed therebetween, and is adhered to the energy storage devices 200 by the adhesive material 700. Specifically, the first uneven surface 215 or the second uneven surface 216 of the terminal arrangement surface 212c and the adhesive surface 310 or 320 of the bus bar frame 300 are adhered by the adhesive material 700. That is, the adhesive material 700 is applied to at least one of the first uneven surfaces 215 (or the second uneven surfaces 216) of the energy storage devices 200 and the adhesive surface 310 of the bus bar frame 300 so that the first uneven surfaces 215 (or the second uneven surfaces 216) and the adhesive surface 310 are adhered to each other. The same applies to adhesion between the second uneven surfaces 216 (or the first uneven surfaces 215) and the adhesive surface 320. In the present embodiment, each of the first uneven surface 215 and the second uneven surface 216 has concave portions having a shape in which a width of a tip portion increases as a depth increases (or convex portions having a shape in which the width increases toward the tip), and the adhesive material 700 enters the concave portion, so that an anchor effect is generated.

The adhesive material 700 is an adhesive material which adheres the energy storage devices 200 and the bus bar frame 300 (adjacent member) to each other. As the adhesive used for the adhesive material 700, a resin adhesive or the like that is in a liquid state before adhesion and is adhered by being in a solid state can be used. As the adhesive material 700, a material that is in a gel state before adhesion, a solid material such as a hot melt adhesive, or the like can also be used.

As shown in FIG. 6, the outer case body 110 of the outer case 100 has planar adhesive surfaces 112 (also referred to as second adhesive surfaces) at positions facing the third uneven surfaces 217 of the bottom surfaces 211c of the energy storage devices 200. In the present embodiment, the outer case body 110 has a plurality of ribs 111 extending in the X axis direction on a bottom surface thereof, and adhesive surfaces 112 are arranged at positions sandwiching the respective ribs 111. The third uneven surfaces 217 of the bottom surfaces 211c of the energy storage devices 200 and the adhesive surfaces 112 of the outer case body 110 are adhered to each other. As described above, the bottom surface 211c of the energy storage device 200 is an adhesive surface (also referred to as a first adhesive surface) to be adhered to the outer case 100 (adjacent member).

The adhesive surfaces 112 are provided on the bottom surface of the outer case body 110, but are not necessarily provided on the ribs 111 arranged on the bottom surface. That is, the adhesive material 700 described later is provided between the adhesive surfaces 112 of the bottom surface of the outer case body 110 and the bottom surfaces 211c of the energy storage devices 200, but may not be provided between the ribs 111 and the bottom surfaces 211c of the energy storage devices 200. According to this aspect, by adjusting the heights of the ribs 111 to the optimum thickness at which the adhesive material 700 can exert the maximum adhesive force, the thickness of the adhesive material 700 can be optimally managed only by pressing the energy storage device 200 against the ribs 111. When the adhesive material 700 is in a liquid state before being cured, the adhesive material 700 can be applied not only to the adhesive surfaces 112 but also to the ribs 111, and the adhesive material 700 can be removed from the ribs 111 by the above-described method of pressing the energy storage devices 200 against the ribs 111.

To be more specific, as shown in FIG. 7, similarly to the bus bar frame 300, the outer case 100 is arranged adjacent to the energy storage devices 200 with the adhesive material 700 interposed therebetween, and is adhered to the energy storage devices 200 by the adhesive material 700. To be more specific, the third uneven surfaces 217 of the bottom surfaces 211c of the energy storage devices 200 and the adhesive surfaces 112 of the outer case body 110 are adhered to each other by the adhesive material 700. That is, the adhesive material 700 is applied to at least one of the third uneven surfaces 217 and the adhesive surfaces 112, and the third uneven surfaces 217 and the adhesive surfaces 112 are adhered to each other. For example, by applying the adhesive material 700 to the bottom surfaces 211c in a state where the bottom surfaces 211c of the energy storage devices 200 are directed upward and covering the energy storage devices 200 with the outer case body 110, the third uneven surfaces 217 are adhered to the bottom surfaces 211c.

As the adhesive material 700 for adhering the energy storage devices 200 and the outer case 100 to each other, the same adhesive material as the above-mentioned adhesive material for adhering the energy storage devices 200 and the bus bar frame 300 to each other can be used. The third uneven surface 217 has the same shape as the first uneven surface 215 and the second uneven surface 216, and is configured to produce an anchor effect. In the present embodiment, the third uneven surface 217 is formed on the case corner portion 211d of the energy storage device 200 similarly to the bottom surface 211c and is adhered to the adhesive surfaces 112 of the outer case body 110, but the detailed description is omitted since it is similar to the bottom surface 211c.

### 4 Description of Effects

As has been described heretofore, according to the energy storage apparatus 10 of the embodiment of the present invention, the energy storage device 200 includes the adhesive surfaces (the terminal arrangement surface 212c and the bottom surface 211c) to be adhered to the adjacent members (the bus bar frame 300 and the outer case 100) arranged adjacently to the energy storage device 200 by the adhesive material 700. The adhesive surfaces include the uneven surfaces (the first uneven surface 215, the second uneven surface 216, and the third uneven surface 217) on which an uneven shape spreads in a planar shape. In this manner, by forming the uneven surface on which an uneven shape spreads in a planar shape on the adhesive surface of the energy storage device 200 to the adjacent member, the adhesion area of the adhesive surface can be increased. With such a configuration, it is possible to improve an adhesive force between the energy storage device 200 and the adjacent member, and hence the movement of the energy storage device 200 in the energy storage apparatus 10 can be suppressed. Since the anchor effect can be generated by forming the uneven surface on the adhesive surface, it is possible to further improve the adhesive force between the energy storage device 200 and the adjacent member. Accordingly, the movement of the energy storage device 200 in the energy storage apparatus 10 can be further suppressed.

Conventionally, there has been a case where a surface of the case 210 of the energy storage device 200 is subjected to plasma treatment to improve an adhesive force with an adjacent member. However, when the surface of the case 210 is subjected to plasma treatment, there is also a problem that the effect of the plasma treatment varies. Therefore, the inventor of the present application has found that it is effective to form an uneven surface on which an uneven shape spreads in a planar shape on the adhesive surface in order to reduce variations in adhesive force. In this manner, the variations in adhesive force between the energy storage device 200 and the adjacent member can be suppressed by a simple operation of forming the uneven surface on the adhesive surface, and hence the movement of the energy storage device 200 in the energy storage apparatus 10 can be suppressed.

The adhesive surface of the energy storage device 200 to the adjacent member includes the uneven surface which is rougher than the surface adjacent to the adhesive surface or the surface on the back side. In this manner, by making the uneven surface of the adhesive surface of the energy storage device 200 rougher than other surfaces (the adjacent surfaces or the surface on the back side), the adhesive force on the uneven surface can be improved. With such a configuration, it is possible to improve an adhesive force between the energy storage device 200 and the adjacent member, and hence the movement of the energy storage device 200 in the energy storage apparatus 10 can be suppressed.

The adhesive surface of the energy storage device 200 to the outer case 100 includes the third uneven surface 217 which is an uneven surface of the bottom surface 211c of the energy storage device 200. That is, the energy storage device 200 can be stably fixed in the energy storage apparatus 10 in many cases by adhering the bottom surface 211c of the energy storage device 200 to the outer case 100, and hence the third uneven surface 217 is provided on the bottom surface 211c of the energy storage device 200. With such a configuration, by improving the adhesive force between the bottom surface 211c of the energy storage device 200 and the outer case 100, the energy storage device 200 can be more stably fixed in the energy storage apparatus 10, and hence the movement of the energy storage device 200 in the energy storage apparatus 10 can be further suppressed.

It can also be said that the adhesive surface of the energy storage device 200 to the outer case 100 includes the third uneven surface 217 which is an uneven surface of a surface on the side opposite to the electrode terminals 220. That is, the movement of the electrode terminal 220 side of the energy storage device 200 is bound by the electrode terminals 220 being connected to the bus bars 400, but the side of the energy storage device 200 which is opposite to the electrode terminals 220 is easily moved. Thus, the third uneven surface 217 is formed on the surface of the energy storage device 200 on the side opposite to the electrode terminals 220. With such a configuration, by improving the adhesive force between the surface of the energy storage device 200 on the side opposite to the electrode terminals 220 and the outer case 100, the movement of the side of the energy storage device 200 which is opposite to the electrode terminals 220 can also be suppressed, and hence the movement of the energy storage device 200 in the energy storage apparatus 10 can be further suppressed.

The adhesive surfaces of the energy storage device 200 to the bus bar frame 300 are arranged in the adhesive regions 230 of the terminal arrangement surface 212c which is a surface of the energy storage device 200 on the electrode terminal 220 side, and include the first uneven surface 215 and the second uneven surface 216 which are uneven surfaces rougher than the non-adhesive regions 240. That is, when the bus bar frame 300 is adhered to the terminal arrangement surface 212c of the energy storage device 200, the bus bar frame 300 is adhered to some surfaces (adhesive regions 230) so as to avoid the gas release valve 212a, the electrode terminals 220, and the like. Therefore, on the terminal arrangement surface 212c of the energy storage device 200, the first uneven surface 215 and the second uneven surface 216 having an uneven shape rougher than the non-adhesive regions 240 are formed in the adhesive regions 230. With such a configuration, it is possible to improve the adhesive force between the terminal arrangement surface 212c of the energy storage device 200 and the bus bar frame 300, and hence the movement of the energy storage device 200 in the energy storage apparatus 10 can be suppressed.

### 5 Description of Modification Examples

### First Modification Example

Next, a first modification example of the above-mentioned embodiment will be described. FIG. 8 is an enlarged cross-sectional view showing a state where the energy storage devices 200 and the outer case 100 according to the first modification example of the present embodiment are adhered to each other. Specifically, FIG. 8 is a view corresponding to FIG. 7.

As shown in FIG. 8, in the present modification example, unlike the above-mentioned embodiment, the energy storage device 200 does not have the third uneven surface 217 on the bottom surface 211c of the case body 211, and the outer case 100 has an uneven surface 113 on each of the adhesive surfaces 112 of the outer case body 110. Other configurations are the same as those of the above-mentioned embodiment, and thus detailed description thereof is omitted.

The uneven surface 113 has the same shape as the first uneven surface 215, the second uneven surface 216, and the third uneven surface 217 described above. As described above, the outer case 100 (adjacent member) has the second adhesive surface (adhesive surfaces 112) to be adhered to the first adhesive surfaces (bottom surfaces 211c) of the energy storage devices 200, and the second adhesive surface has the uneven surface (uneven surface 113) on which an uneven shape spreads in a planar shape. The uneven surface 113 can be formed, for example, by the same method as the above-mentioned method for forming the uneven surface on the energy storage device 200 or by performing embossing on the adhesive surface 112 of the outer case body 110.

In the present modification example, similarly to the above-mentioned embodiment, the third uneven surface 217 may also be formed on the bottom surface 211c (first adhesive surface) of the energy storage device 200. That is, it is sufficient that at least one of the first adhesive surface and the second adhesive surface may has an uneven surface on which an uneven shape spreads in a planar shape. From the viewpoint of improving the adhesive force, it is preferable that both the first adhesive surface and the second adhesive surface have an uneven surface.

As described above, the energy storage apparatus according to the present modification example can acquire substantially the same effects as the above-mentioned embodiment. In particular, in the present modification example, at least one of the first adhesive surface which is a surface of the energy storage device 200 on the side opposite to the bottom surface 211c or the electrode terminals 220 and the second adhesive surface of the outer case 100 (adjacent member) has an uneven surface on which an uneven shape spreads in a planar shape. By forming the uneven surface on at least one of the first adhesive surface and the second adhesive surface as described above, it is possible to increase the adhesion area of the adhesive surface, and hence it is possible to improve the adhering force between the energy storage device 200 and the outer case 100. That is, by improving the adhesive force between the bottom surface 211c of the energy storage device 200 and the outer case 100, the energy storage device 200 can be more stably fixed in the energy storage apparatus 10. By improving the adhesive force between the surface of the energy storage device 200 on the side opposite to the electrode terminals 220 and the outer case 100, the movement of the side of the energy storage device 200 which is opposite to the electrode terminals 220, which is not bound in movement by the bus bars 400, can also be suppressed. Accordingly, the movement of the energy storage device 200 in the energy storage apparatus 10 can be further suppressed. Since the anchor effect can be generated by forming the uneven surface on the adhesive surface, it is possible to further improve the adhesive force between the energy storage device 200 and the outer case 100, and it is possible to further suppress the movement of the energy storage device 200 in the energy storage apparatus 10.

The present modification example can be applied not only to the adhesive surface 112 of the outer case 100 but also to the adhesive surfaces 310 and 320 of the bus bar frame 300. That is, an uneven surface may be formed on at least one of the adhesive surfaces 310 and 320 of the bus bar frame 300. In this case, the first uneven surface 215 and the second uneven surface 216 may be formed on the terminal arrangement surface 212c of the energy storage device 200, or at least one of the first uneven surface 215 and the second uneven surface 216 may not be formed. That is, it is sufficient that at least one of the terminal arrangement surface 212c of the energy storage device 200 and the adhesive surfaces 310 and 320 of the bus bar frame 300 has an uneven surface on which an uneven shape spreads in a planar shape.

### Second Modification Example

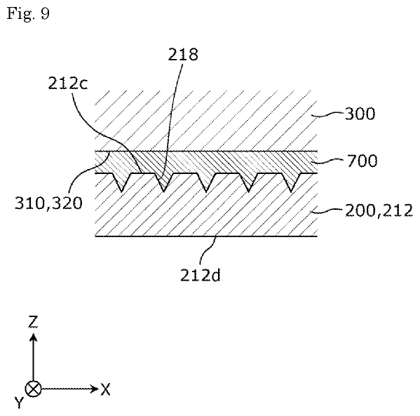

Next, a second modification example of the above-mentioned embodiment will be described. FIG. 9 is an enlarged cross-sectional view showing a state where the energy storage devices 200 and the bus bar frame 300 according to the second modification example of the present embodiment are adhered to each other. Specifically, FIG. 9 is a view corresponding to FIG. 5.

As shown in FIG. 9, in the present modification example, unlike the above-mentioned embodiment, the energy storage device 200 has a third uneven surface 218 on the terminal arrangement surface 212c of the lid portion 212. Other configurations are the same as those of the above-mentioned embodiment, and thus detailed description thereof is omitted.

The third uneven surface 218 has concave portions having a triangular cross section in the XZ plane. The shape of the concave portions (or the convex portions) of the third uneven surface 218 may not be the triangular shape, and may be any shape such as a rectangular shape, another polygonal shape, a semicircular shape, a semi-oval shape, or a semi-elliptic shape. As described above, the shape of the concave portions or the convex portions formed on the uneven surface is not particularly limited, and concave portions or convex portions having any shape may be formed.

As described above, the energy storage apparatus according to the present modification example can acquire substantially the same effects as the above-mentioned embodiment. In particular, in the present modification example, the shape of the concave portions (or the convex portions) of the third uneven surface 218 is not limited, and hence the third uneven surface 218 can be easily formed on the terminal arrangement surface 212c of the energy storage device 200.

The present modification example can be applied to all the uneven surfaces provided on the adhesive surfaces other than the terminal arrangement surface 212c of the energy storage device 200.

### Other Modification Examples

Although the energy storage apparatus according to the present embodiment and the modification examples thereof have been described above, the present invention is not limited to the above-mentioned embodiment and the modification examples thereof. That is, the embodiment and the modification examples thereof disclosed herein are illustrative in all respects and are not restrictive, and the scope of the present invention includes all modification examples within the meaning and scope equivalent to the claims.

In the above-mentioned embodiment and the modification examples thereof, the outer case 100 (the outer case body 110) and the bus bar frame 300 are described as examples of the adjacent members arranged adjacent to the energy storage devices 200, but the adjacent members are not limited thereto. Examples of the adjacent members include various members such as an insulating member (resin member) arranged adjacent to the energy storage device 200 such as an intermediate spacer arranged between two energy storage devices 200 or an end spacer arranged adjacent to the energy storage device 200 at an end portion. As a concept, the adjacent members include, as an example, a member such as the above-mentioned insulating member (resin member) and does not include, as an example, another energy storage device 200 arranged adjacent to the energy storage device 200.

In the above-mentioned embodiment and the modification examples thereof, the energy storage apparatus is a non-binding type energy storage apparatus in which the plurality of energy storage devices 200 are not bound by a binding member (a side plate, an end plate, or the like). However, the energy storage apparatus may be a binding type energy storage apparatus in which the plurality of energy storage devices 200 are bound by a binding member. In this case, the binding member (the side plate, the end plate, or the like) may be adhered to the energy storage device 200 as an example of the adjacent member. However, the non-binding type energy storage apparatus is desired to suppress the movement of the energy storage device 200, and thus the effect of applying the present application is high.

When the intermediate spacer, the end spacer, the another energy storage device 200, or the binding member (the side plate, the end plate, or the like) is provided as the adjacent member, an uneven surface is formed on the long side surface 211a or the short side surface 211b of the case body 211 of the energy storage device 200, or an uneven surface is formed on the intermediate spacer or the like. That is, at least one of the long side surface 211a of the case body 211 of the energy storage device 200 and the adjacent member adjacent to the long side surface 211a may have an uneven surface on which an uneven shape spreads in a planar shape. At least one of the short side surface 211b of the case body 211 of the energy storage device 200 and the adjacent member adjacent to the short side surface 211b may have an uneven surface on which an uneven shape spreads in a planar shape. In this case, the energy storage device 200 may not include the insulating sheet 214. In the energy storage device 200, an uneven surface may be formed on the insulating sheet 214 instead of forming an uneven surface on the case body 211.

In the above-mentioned embodiment and the modification examples thereof, the uneven surfaces such as the first uneven surface 215, the second uneven surface 216, and the third uneven surfaces 217 and 218 are rougher than the surface adjacent to the uneven surface or the surface on the back side of the uneven surface. However, the uneven surfaces may be rougher than surfaces different from the adjacent surface and the surface on the back side. The uneven surfaces may have the same roughness as the other surfaces or may not be rougher than the other surfaces as long as the uneven surfaces increase an adhesion area or have a roughness capable of causing an anchor effect.

In the above-mentioned embodiment and the modification examples thereof, the surface (bottom surface 211c) of the energy storage device 200 on the side opposite to the electrode terminals 220 is the bottom surface of the energy storage device 200. However, when the energy storage device 200 is arranged in a state where the energy storage device 200 is laid down on its side or arranged in a state where the energy storage device 200 is inverted, the long side surface 211a, the short side surface 211b, or the terminal arrangement surface 212c serves as the bottom surface of the energy storage device 200.

In the above-mentioned embodiment and the modification examples thereof, all the energy storage devices 200 have the above-mentioned configuration. However, any one of the energy storage devices 200 may not have the above configuration. Either the terminal arrangement surface 212c side or the bottom surface 211c side of the energy storage device 200 may not have the above configuration.

A form constructed by freely combining the components included in the above-mentioned embodiment and the modification examples thereof is also included in the scope of the present invention.

The present invention can be realized not only as such an energy storage apparatus but also as the energy storage device 200 having the adhesive surface (first adhesive surface) or the adjacent member (the outer case 100, the bus bar frame 300, or the like) having the second adhesive surface.

### INDUSTRIAL APPLICABILITY

The present invention can be applied to an energy storage apparatus or the like including an energy storage device such as a lithium ion secondary battery.

### DESCRIPTION OF REFERENCE SIGNS

10: energy storage apparatus
100: outer case
110: outer case body
112, 310, 320: adhesive surface
113: uneven surface
200: energy storage device
210: case
211: case body
211a: long side surface
211b: short side surface
211c: bottom surface
211d: case corner portion
211e: bottom surface inner surface
212: lid portion
212a: gas release valve
212b: electrolyte solution filling portion
212c: terminal arrangement surface
212d: lid portion inner surface
215: first uneven surface
216: second uneven surface
217, 218: third uneven surface
220: electrode terminal
230, 330: adhesive region
240, 340: non-adhesive region
300: bus bar frame
700: adhesive material

1. An energy storage apparatus, comprising:
an energy storage device;
an adjacent member arranged adjacent to the energy storage device; and
an adhesive material which adheres the energy storage device and the adjacent member to each other,
wherein the energy storage device includes an adhesive surface to be adhered to the adjacent member by the adhesive material, and
the adhesive surface includes an uneven surface on which an uneven shape spreads in a planar shape.

2. The energy storage apparatus according to claim 1, wherein the adhesive surface includes an uneven surface which is rougher than a surface adjacent to the adhesive surface or a surface on a back side of the adhesive surface.

3. The energy storage apparatus according to claim 1, wherein the adhesive surface includes an uneven surface arranged on a bottom surface of the energy storage device.

4. The energy storage apparatus according to claim 1, wherein the adhesive surface includes an uneven surface arranged on a surface of the energy storage device on a side opposite to an electrode terminal.

5. The energy storage apparatus according to claim 1, wherein
a surface of the energy storage device on which an electrode terminal is arranged includes an adhesive region to be adhered to the adjacent member and a non-adhesive region not to be adhered to the adjacent member, and
the adhesive surface includes an uneven surface which is arranged in the adhesive region and is rougher than the non-adhesive region.

6. An energy storage apparatus, comprising:
an energy storage device; and
an adjacent member arranged adjacent to the energy storage device,
wherein the energy storage device includes a first adhesive surface which is a bottom surface or a surface on a side opposite to an electrode terminal and is to be adhered to the adjacent member,
the adjacent member includes a second adhesive surface to be adhered to the first adhesive surface, and
at least one of the first adhesive surface and the second adhesive surface includes an uneven surface on which an uneven shape spreads in a planar shape.
